(19) United States
(12) Patent Application Publication
(10) Pub. No.: US 2008/0218442 A1
(43) Pub. Date: Sep. 11, 2008

(54) METHOD FOR DRIVING PLASMA DISPLAY PANEL

(76) Inventors: Jae-Seok Jeong, Suwon-si (KR); Myoung-Kwan Kim, Suwon-si (KR)

Correspondence Address: CHRISTIE, PARKER & HALE, LLP, PO BOX 7068, PASADENA, CA, 91109-7068, US

(21) Appl. No.: 12/043,061

(22) Filed: Mar. 5, 2008

(30) Foreign Application Priority Data
Mar. 8, 2007 (KR) 10-2007-0022934

(51) Int. Cl. G09G 3/28

(52) U.S. Cl. 345/60

(57) ABSTRACT

A method for driving a plasma display panel including a plurality of pixels, a plurality of first electrode lines, a plurality second electrode lines, and a plurality of third electrode lines crossing the first electrode lines and the second electrode lines, and being driven by dividing a frame into a plurality of subfields, each subfield including a reset period, an address period and a sustain discharge period, the method including: applying a first pre-address signal to a first group of third electrode lines among the plurality of third electrode lines in a pre-address period, the pre-address period being between the reset period and the address period in at least one of the subfields; and applying a second pre-address signal to at least a second group of third electrode lines among the plurality of third electrode lines in the pre-address period.

### CROSS-REFERENCE TO RELATED APPLICATIONS

This application claims priority to and the benefit of Korean Patent Application No. 2007-0022934, filed on Mar. 8, 2007, in the Korean Intellectual Property Office, the entire content of which is incorporated herein by reference.

### BACKGROUND

1. Field of the Invention

The present invention relates to a method for driving a plasma display panel, and, more particularly, to a method for driving a plasma display panel capable of minimizing electromagnetic interference (EMI).

2. Discussion of Related Art

Plasma display panels (hereinafter, referred to as ‘PDPs’) are flat panel display devices for displaying letters or images by light emission from phosphors as a result of plasma generated when gas is discharged. PDPs have higher brightness and luminous efficiency, and wider viewing angle than liquid crystal displays (LCDs) and field emission displays (FEDs), and may be used as replacements for cathode ray tubes (CRTs).

Plasma display panels may be a DC type or an AC type, according to a pixel structure arranged in a matrix form and a voltage waveform of a driving signal. In the DC type, all electrodes are exposed to a discharge space so that movement of charges between the corresponding electrodes is directly made. However, in the AC type, at least one electrode of the corresponding electrodes is surrounded by a dielectric so that movement of charges between the corresponding electrodes is not directly made.

The plasma display panel having the above structure displays multiple gray level images in a time division driving method by dividing a unit frame into a plurality of subfields. Each subfield is driven in a reset period for making the charge state of pixels substantially uniform, an address period for accumulating wall charges on pixels to be driven, and a sustain discharge period for sustaining discharge of the pixels. For such driving, each electrode is applied with a driving signal in a voltage waveform (e.g., a predetermined voltage waveform).

However, as shown in FIG. 1, when all pixels connected to scan electrode lines Y₁, . . . , Yₙ of the plasma display panel are selected in the address period, an address signal with a voltage level V_{A} is applied to all address electrode lines A₁, . . . , Aₘ, and therefore, instantaneous current variations are very large. In other words, the peak level of EMI is high due to high variations in the instantaneous current. Here, an input signal may be distorted by noise due to the EMI, and image degradation, such as dot noise, occurs as a result of errors in display data.

### SUMMARY OF THE INVENTION

An aspect of an embodiment of the present invention is directed to a method for driving a plasma display panel for minimizing electromagnetic interference.

An embodiment of the present invention provides a method for driving a plasma display panel including a plurality of pixels, a plurality of first electrode lines, a plurality second electrode lines, and a plurality of third electrode lines crossing the first electrode lines and the second electrode lines, and being driven by dividing a frame into a plurality of subfields, each subfield including a reset period, an address period and a sustain discharge period, the method including: applying a first pre-address signal to a first group of third electrode lines among the plurality of third electrode lines in a pre-address period, the pre-address period being between the reset period and the address period in at least one of the subfields; and applying a second pre-address signal to at least a second group of third electrode lines among the plurality of third electrode lines in the pre-address period.

Another embodiment of the present invention provides a method for driving the plasma display panel including a plurality of pixels, a plurality of first electrode lines, a plurality of second electrode lines, and a plurality of third electrode lines crossing the first electrode lines and the second electrode lines, and being driven by dividing a frame into a plurality of subfields, each subfield including a reset period, an address period and a sustain discharge period, the method including: dividing the plurality of third electrode lines into a plurality of groups; and applying pre-address signals to the third electrode lines from a first group to a last group at a time interval in a pre-address period, the pre-address period being between the reset period and the address period in at least one of the subfields.

Another embodiment of the present invention provides a plasma display panel configured to be driven during a plurality of subfields of a frame, each subfield including a reset period, an address period, a sustain period, and a pre-address period between the reset period and the address period, the plasma display panel including: a plurality of pixels for displaying an image; a plurality of first electrode lines and a plurality of second electrode lines that are parallel to each other; a plurality of third electrode lines including at least a first group and a second group of third electrode lines and crossing the first and second electrode lines, and for applying address signals; and an address driver for providing the address signals to the third electrode lines during the address period, and for providing pre-address signals to the first group of the third electrode lines at a first time in the pre-address period and to the second group of the third electrode lines at a second time after the first time in the pre-address period.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 illustrates waveforms for explaining a method for driving a conventional plasma display panel.

FIG. 2 is a perspective view of a plasma display panel according to an embodiment of the present invention.

FIG. 3 is a diagram of a unit frame illustrating a method for displaying multiple gray levels of a plasma display panel according to an embodiment of the present invention.

FIG. 4 illustrates waveforms for explaining a method for driving a plasma display panel according to an embodiment of the present invention.

FIG. 5 is a schematic view of electrode lines for explaining a method for driving a plasma display panel according an embodiment of the present invention.

FIG. 6 is a schematic diagram of a plasma display panel according to an embodiment of the present invention.

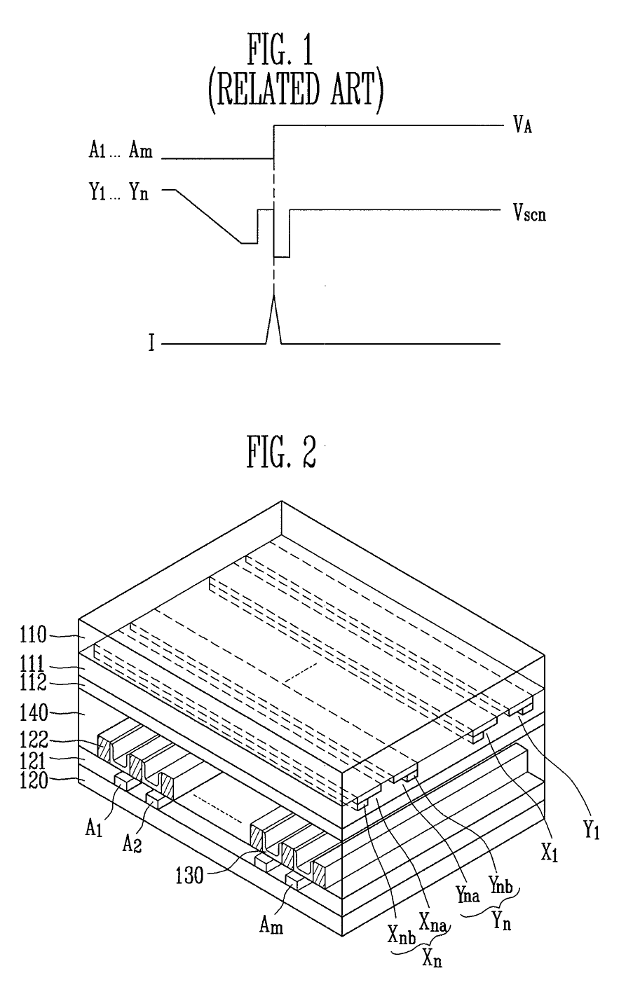

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like numerals designate like elements throughout the specification.

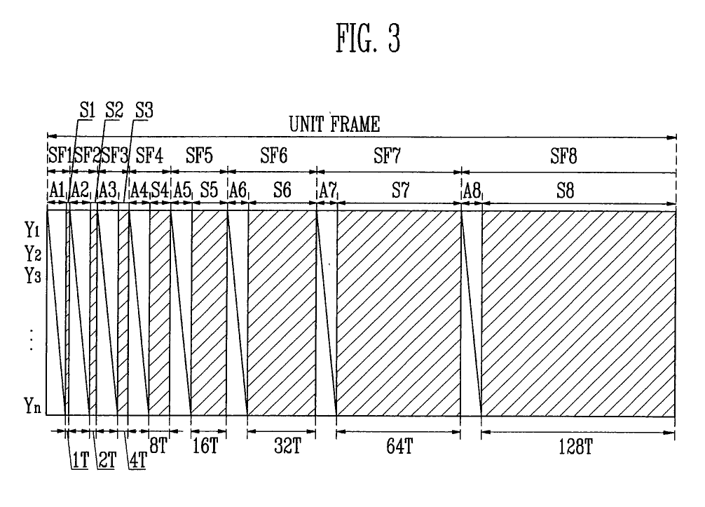

FIG. 2 is a perspective view of a plasma display panel according to an embodiment of the present invention, wherein a plasma display panel in a three-electrode surface light emitting manner is shown. On a first substrate 110, a plurality of sustain electrode lines X₁, . . . , Xₙ and a plurality of scan electrode lines Y₁, . . . , Yₙ, covered with a dielectric 111 and a protective film 112, are formed to be substantially parallel with each other. The sustain electrode lines X₁, . . . , Xₙ and scan electrode lines Y₁, . . . , Yₙ, are formed of transparent electrodes Xₙₐ and Yₙₐ, formed of ITO (Indium Tin Oxide), and metal electrodes X_{nb} and Y_{nb} for improving conductivity, respectively. On a second substrate 120, a plurality of address electrode lines A₁, . . . , Aₘ covered with a dielectric 121 are formed. On the dielectric 121, between the plurality of address electrode lines A₁, . . . , Aₘ, barrier ribs 122 are formed to be substantially parallel to the address electrode lines A₁, . . . , Aₘ. On both sides of the barrier ribs 122 and the dielectric 121, phosphor layers 130 are formed. The first substrate 110 and the second substrate 120 are bonded so that the scan electrode lines Y₁, . . . , Yₙ and the address electrode lines A₁, . . . , Aₘ, and the sustain electrode lines X₁, . . . , Xₙ and the address electrode lines A₁, . . . , Aₘ are substantially orthogonal to each other and discharge spaces 140 enclosed by the barrier ribs 122 are formed. Each discharge space 140 is sealed and contains gas for forming plasma, thereby forming a plurality of pixels. Inert mixing gas, such as He+Xe, Ne+Xe, He+Xe+Ne, etc., may be used as gas for forming plasma.

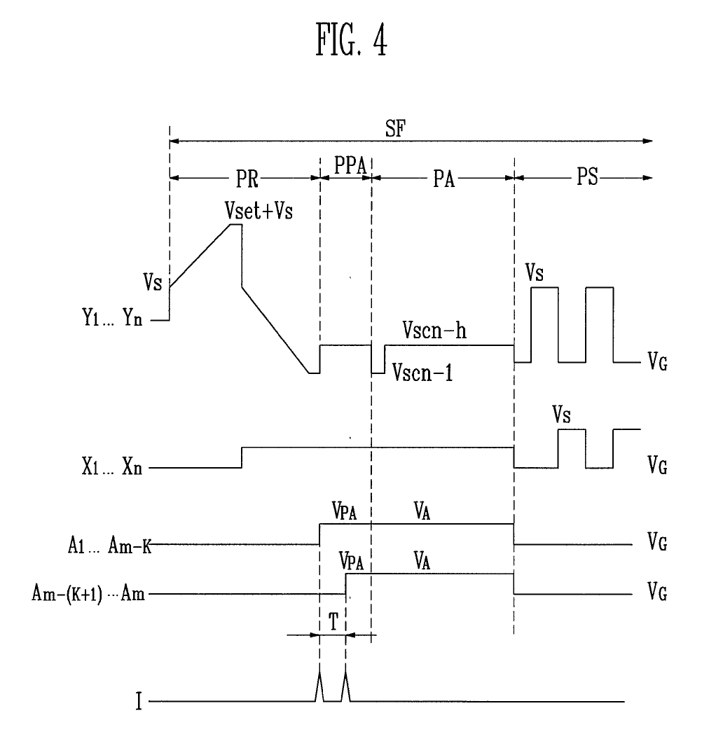

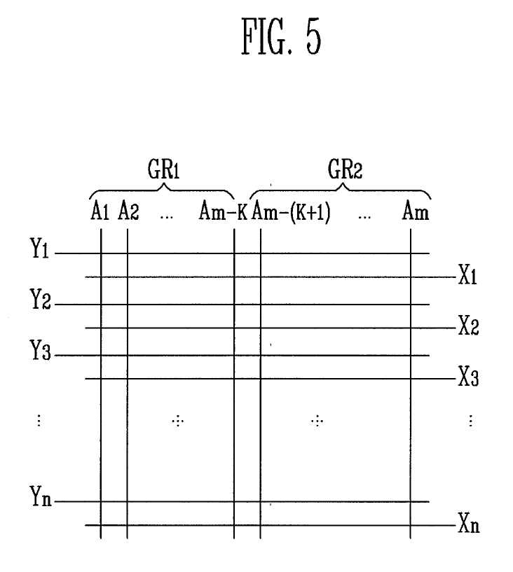

In the plasma display panel described above, as shown in FIG. 3, a unit frame is time divided into a plurality of subfields SF1 to SF8. In each subfield SF1 to SF8, a reset period PR, an address period PA and a sustain discharge period PS, are sequentially performed by a driving signal having a voltage waveform, as shown in FIG. 4, so that an image having desired gray levels is displayed. The method of driving a plasma display panel according to and embodiment of the present invention is characterized in that a pre-address period PPA is included between the reset period PR and the address period PA.

FIG. 4 illustrates waveforms for explaining in more detail a method for driving a plasma display panel according to an embodiment of the present invention, and FIG. 5 is a schematic view of electrode lines.

First, the reset period PR, which is a period for completely erasing the wall charges of pixels on which a sustain discharge was performed in the previous subfield and then making the charge state of each pixel uniform so that the pixels may be smoothly selected, includes a set up period, where a ramp up pulse is applied, and a set down period, where a ramp down pulse is applied.

For example, in the set up period, the ramp up pulses are applied to all the scan electrode lines Y₁, . . . , Yₙ. The ramp up pulses increase from a sustain voltage Vs by a voltage Vset+Vs at a constant slope. The ramp up pulses generate dark discharge that generates a small amount of light in all pixels, positive (+) wall charges are accumulated on the address electrodes A₁, . . . , Aₘ and the sustain electrodes X₁, . . . , Xₙ, and negative (−) wall charges are accumulated on the scan electrodes Y₁, . . . , Yₙ.

In the set down period, ramp down pulses are applied to all the scan electrode lines Y₁, . . . , Yₙ. The ramp down pulse decreases from a positive (+) voltage lower than the set up voltage Vset, for example, at a slope (e.g., a predetermined slope) in the sustain voltage, to a ground voltage V_{G} or a negative (−) specific voltage, for example, a negative (−) scan voltage Vscn−1. Some of the excessive wall charges formed in the set up period are erased by the ramp down pulse, so that the amount of wall charges in all of the pixels is substantially uniform and an address discharge can stably occur.

The pre-address period PPA is a period for decreasing current variations. The address electrode lines A₁, . . . , Aₘ are divided into a plurality of groups in order to apply sequentially pre-address signals V_{PA} from a first group to a last group to the address electrode lines A₁, . . . , Aₘ. The pre-address signals V_{PA} are applied at time T intervals (e.g., predetermined time T intervals) in order to reduce or minimize EMI radiation from instantaneous current variations.

As shown in FIG. 5, a plurality of address electrode lines A₁, . . . , Aₘ are divided into a first and a second groups GR1 and GR2, a first pre-address signal V_{PA} is applied to the address electrode lines A₁, . . . , Aₘ₋ₖ of the first group GR1, and a second pre-address signal V_{PA} is applied to the address electrode lines Aₘ₋ₖ₊₁, . . . , Aₘ of the second group GR2. The pre-address signals V_{PA} are formed of a voltage signal identical to an address signal V_{A} applied to the address electrode lines A₁, . . . , Aₘ in the pre-address period PPA, however, it may not include display data.

As described above, the address electrode lines A₁, . . . , Aₘ are divided into a plurality of groups and the pre-address signals V_{PA} are applied to the address electrode lines A₁, . . . , Aₘ from the first group to the last group at time T intervals (e.g., predetermined time T intervals). Therefore, charge current amount is dispersed, and a discharge current and a displacement current are divided, making it possible to efficiently decrease current I variations. Furthermore, when pixels connected to scan electrode lines are selected, the variations of the instantaneous current can be decreased from that of the prior art. Further, when the pixels of the whole display panel are displayed in white, variations of the current can efficiently be decreased. Therefore, because the instantaneous current variations can be decreased from that of the prior art, the peak level of EMI decreases so that malfunction or errors due to noise are reduced or prevented.

Next, the address period PA is a period for accumulating wall charges on the pixels to be driven. In the address period PA, scan signals Vscn−1 are sequentially applied to the scan electrode lines Y₁, . . . , Yₙ, and at the same time, address signals VA, including display data to be synchronized with the scan signals Vscn−1, are applied to the address electrode lines A₁, . . . , Aₘ. In FIG. 4, only one scan signals Vscn−1 is shown for convenience of illustration.

The voltage difference between the scan signal Vscn−1 and the address signal V_{A} is added in a state where a wall voltage (e.g., a predetermined wall voltage) generated during the reset period PR is maintained. Further, address discharge occurs in the pixels where the address signal V_{A} is applied, whereby the wall charges, to the extent that the sustain discharge may occur, are formed in the selected pixels. Here, the sustain signal Vs is applied to the sustain electrodes X₁, . . . , Xₙ to decrease the voltage difference between the sustain electrodes X₁, . . . , Xₙ and the scan electrodes Y₁, . . . , Yₙ, thereby preventing or reducing erroneous discharge.

The sustain discharge period PS is a period for displaying an image by discharge in the selected pixel. In the sustain discharge period PS, the sustain signal Vs is applied in pulse forms having opposite phases to each other in the scan electrode lines Y₁, . . . , Yₙ and the sustain electrode lines X₁, . . . , Xₙ of the selected pixel. The discharge is maintained between the scan electrodes Y₁, . . . , Yₙ and the sustain electrodes X₁, . . . , Xₙ through the sustain pulses by adding the voltage of the sustain signal Vs to the wall voltage of the selected pixel, thereby displaying an image.

When the sustain discharge period PS is completed, a voltage signal having low width and level is applied to all the sustain electrode lines X₁, . . . , Xₙ so that the wall charges remaining in all of the pixels are erased.

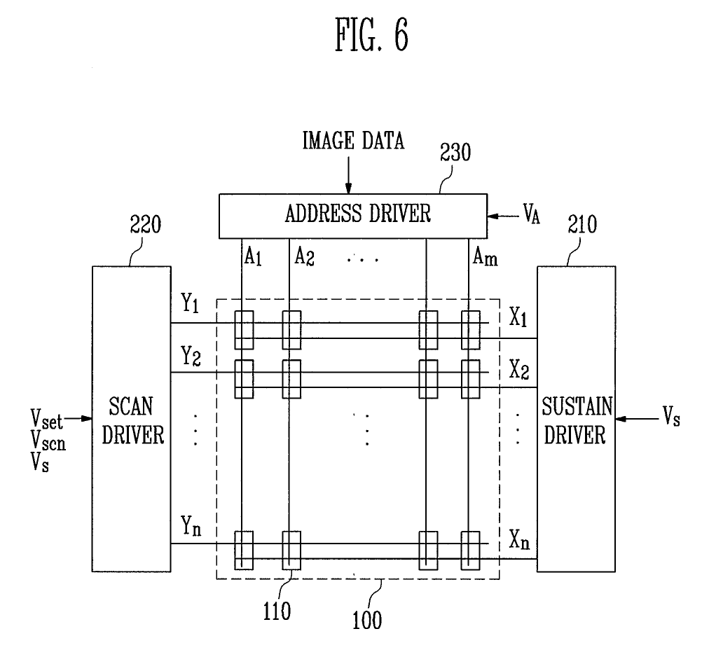

FIG. 6 is a schematic view showing one example of a driver for driving a plasma display panel according to an embodiment of the present invention. In a plasma display panel 100, a plurality of pixels 110 are formed by sustain electrode lines X₁, . . . , Xₙ and scan electrode lines Y₁, . . . , Yₙ arranged to be substantially parallel and cross the address electrode lines A₁, . . . , Aₘ. A sustain driver 210 is connected to the sustain electrode lines X₁, . . . , Xₙ, a scan driver 220 is connected to the scan electrode lines Y₁, . . . , Yₙ, and an address driver 230 is connected to the address electrode lines A₁, . . . , Aₘ.

Also, the plasma display panel 100 may further include an image processor receiving external analog image signals and generating digital image signals, for example, red (R), green (G) and blue (B) image data of 8 bits, a clock signal, and vertical and horizontal synchronizing signals; a logic controller generating control signals according to internal image signals provided from the image processor; and a driving voltage generator generating a set up voltage Vset, a scan voltage Vscn, a sustain voltage Vs, a pre-address voltage V_{PA}, an address voltage V_{A}, etc.

The sustain driver 210 applies the sustain signal Vs to the sustain electrode lines X₁, . . . , Xₙ according to the control signal; the scan driver 220 applies the ramp pulse, the scan signal Vscn and the sustain signal Vs to the scan electrode lines Y₁, . . . , Yₙ according to the control signal; and the address driver 230 applies the pre-address signals V_{PA} and/or the address signals V_{A}, including the display data, to the address electrode lines A₁, . . . , Aₘ from the first group to the last group at time (T) intervals (e.g., predetermined time T intervals) according to the control signal.

Conventionally, signals are simultaneously applied to all the address electrode lines and all the scan electrode lines at the beginning of the address period so that the current variations according to time become very large when all the pixels or a plurality of pixels connected to one scan electrode line are displayed. In an embodiment of the present invention, the pre-address period is included between the reset period and the address period. In the pre-address period, the pre-address signals are applied to the address electrode lines from the first group to the last group at time intervals (e.g., predetermined time intervals). In the pre-address period, the charge current amount is dispersed and a discharge current and a displacement current are divided. Therefore, as the current variations according to time decrease, the EMI radiation amount decreases, making it possible to prevent or reduce malfunction or errors due to noise and prevent or reduce low discharge by stably applying the address signal.

Although an embodiment of the present invention is described focusing on the AC type plasma display panel, it may also be applied to the DC plasma display panel. Also, it would be appreciated by a person having ordinary skill in the art that various modifications and equivalent other embodiments to the voltage conditions applied to each electrode line in a reset period, a pre-address period, an address period and a sustain discharge period can be made. While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for driving a plasma display panel comprising a plurality of pixels, a plurality of first electrode lines, a plurality second electrode lines, and a plurality of third electrode lines crossing the first electrode lines and the second electrode lines, and being driven by dividing a frame into a plurality of subfields, each subfield comprising a reset period, an address period and a sustain discharge period, the method comprising:
applying a first pre-address signal to a first group of third electrode lines among the plurality of third electrode lines in a pre-address period, the pre-address period being between the reset period and the address period in at least one of the subfields; and
applying a second pre-address signal to at least a second group of third electrode lines among the plurality of third electrode lines in the pre-address period.

2. The method for driving the plasma display panel as claimed in claim 1, wherein a time interval exists between the first pre-address signal and the second pre-address signal are applied at.

3. The method for driving the plasma display panel as claimed in claim 1, wherein display data are not included in the first pre-address signal or the second pre-address signal.

4. The method for driving the plasma display panel as claimed in claim 1, wherein the first pre-address signal and the second pre-address signal are applied in a first subfield among the plurality of subfields of the unit frame.

5. A method for driving the plasma display panel comprising a plurality of pixels, a plurality of first electrode lines, a plurality of second electrode lines, and a plurality of third electrode lines crossing the first electrode lines and the second electrode lines, and being driven by dividing a frame into a plurality of subfields, each subfield comprising a reset period, an address period and a sustain discharge period, the method comprising:
dividing the plurality of third electrode lines into a plurality of groups; and
applying pre-address signals to the third electrode lines from a first group to a last group at a time interval in a pre-address period, the pre-address period being between the reset period and the address period in at least one of the subfields.

6. The method for driving the plasma display panel as claimed in claim 5, wherein display data are not included in the pre-address signals.

7. The method for driving the plasma display panel as claimed in claim 4, wherein the applying the pre-address signals is performed in a first subfield among the plurality of subfields of the frame.

8. A plasma display panel configured to be driven during a plurality of subfields of a frame, each subfield comprising a reset period, an address period, a sustain period, and a pre-address period between the reset period and the address period, the plasma display panel comprising:
a plurality of pixels for displaying an image;
a plurality of first electrode lines and a plurality of second electrode lines that are parallel to each other;
a plurality of third electrode lines comprising at least a first group and a second group of third electrode lines and crossing the first and second electrode lines, and for applying address signals; and
an address driver for providing the address signals to the third electrode lines during the address period, and for providing pre-address signals to the first group of the third electrode lines at a first time in the pre-address period and to the second group of the third electrode lines at a second time after the first time in the pre-address period.

9. The plasma display panel of claim 8 further comprising a scan driver for providing a driving signal to plurality of first electrode lines during the reset period.

10. The plasma display panel of claim 8 further comprising a sustain driver for providing a driving signal to the plurality of second electrodes during the sustain period.
